(19) United States
(12) Patent Application Publication
(10) Pub. No.: US 2010/0165892 A1
(43) Pub. Date: Jul. 1, 2010

(54) APPARATUS AND METHOD FOR IMPLEMENTING EFFICIENT REDUNDANCY AND WIDENED SERVICE COVERAGE IN RADIO ACCESS STATION SYSTEM

(75) Inventors: Young-Jae Cha, Seongnam-si (KR); Mun-Kyu Lee, Seoul (KR)

Correspondence Address: AMPACC Law Group, 3500 188th Street S.W., Suite 103, Lynnwood, WA, 98037, US

(73) Assignee: POSDATA CO., LTD., Seongnam-si (KR)

(21) Appl. No.: 12/280,110

(22) PCT Filed: Feb. 26, 2007
(86) PCT No.: PCT/KR2007/000982

§ 371 Date: Aug. 20, 2008

(30) Foreign Application Priority Data
Feb. 28, 2006 (KR) 10-2006-0019394
Feb. 28, 2006 (KR) 10-2006-0019395

(51) Int. Cl. H04J 3/00

(52) U.S. Cl. 370/280

(57) ABSTRACT

Disclosed is an apparatus and a method for implementing efficient redundancy and an expanded service coverage in a Radio Access Station (RAS) system. In the RAS system, if the main processor unit generates switching control signals in response to the sensed failures on sensing a failure in any of the channel cards and the transceivers or a failure in any of the high-power amplifiers, all supporting M (i.e., the number of FAs equal to or more than three) and K (i.e., the number of sectors equal to or more than three), between the transceivers and the predetermined Time Division Duplex (TDD) switches connected to the antennas, the RF switch unit switches a path based on the generated switching control signals so as to substitute the failed module either by one additional redundancy transceiver per M and K or by one additional redundancy high-power amplifier per M and K. As a result, an efficient N+1 redundancy structure is embodied.

### TECHNICAL FIELD

The present invention relates to a wireless communication system, and more particularly to an apparatus and a method for implementing efficient redundancy and widened service coverage in a radio access station system based on the standards of IEEE 802.16d/e, Wireless Broadband Internet (WiBro), World Interoperability for Microwave Access (WiMAX), etc.

### BACKGROUND ART

Recently, in order to realize the fourth-generation mobile communication, in-depth studies are in progress in all social standings. In the fourth-generation mobile communication based on IEEE 802.16d/e, Wireless Broadband Internet (WiBro), World Interoperability for Microwave Access (WiMAX) standards, and so on, a satellite network, a wireless LAN network, digital audio broadcasting and video broadcasting network, etc., are combined into a single network linked with the parts working in coordination, and accordingly, a user is now able to be offered a harmonious service such as WiBro, etc., in a best state, even in any network.

In order to boost the data transfer rate in the fourth-generation mobile communication, the technology of Time Division Duplex (TDD) is considered along with the technology of Orthogonal Frequency Division Multiplexing (OFDM). In the technology of OFDM, data modulated in the schemes of Quadrature Phase Shift Keying (QPSK), Quadrature Amplitude Modulation (QAM), etc., is distributed over multiple carriers having the orthogonality in the frequency domain, and accordingly data stream is processed in parallel, so that the data transfer rate is improved. In the technology of TDD, the quantity of data transmission in a Down Link (DL) from a Radio Access Station (RAS) to a Portable Subscriber Station (PSS) and the quantity of data transmission in an Up Link (UL) from the PSS to the RAS are asymmetrical to each other. In other words, in order to overcome insufficiency of frequency bands in a symmetrical transmission scheme such as the usual technology of Code Division Multiple Access (CDMA), the asymmetrical transmission scheme, such as the technology of TDD, has been considered. For example, in the case of the use of the interne, because the quantity of data that the PSS downloads from a RAS system in the DL is much larger than the amount of data that the PSS transmits to the RAS system in the UL, as occasion demands when the transfer rate of the DL should be increased more than the transfer rate of the UL, the technology of TDD can be applied. In the technology of TDD, the duration of a DL frame can be longer than that of an UL frame, and there exist a certain gap for switching between each link. Herein, each gap corresponds either to a Receive/transmission Transition Gap (RTG) or to a Transmission/receive Transition Gap (TTG).

FIG. 1 is a view illustrating a general wireless communication system 100. With reference to FIG. 1, PSSes 120 and 130, RASes 140 and 150, a repeater 160, a certain server 170, etc., can be interconnected through a wireless network 110. The PSSes 120 and 130 can be provide communication services, such as a call, digital broadcasting, download and upload of digital media, etc., by relay of the RASes 140 and 150 in the wireless network. The server 170 can manage subscribers of the PSSes 120 and 130 or provide the PSSes 120 and 130 with necessary contents.

Herein, the RASes 140 and 150 are connected to an Access Control Router (ACR) through an ethernet, and communication data routed by the ARC is transmitted/received to/from the PSS or the server of a relevant destination via a relevant RAS. Also, in order to cover an area where the signal sensitivity is weak only by communication relay of the RASes 140 and 150, the PSSes 120 and 130 are configured to have enough signal sensitivity by using the repeater 160 connected to the RASes 140 and 150.

A system embodying the prior RAS adopts the redundancy structure in preparation for a failure of the main part. It is usual that the redundancy structure is accomplished by having an extra transceiver and an extra high-power amplifier per each sector of an antenna or per Frequency Assignment (FA) in preparation for failures of a channel card, a transceiver, a high-power amplifier, etc., for transmitting/receiving a Radio Frequency (RF) signal in an RAS system. For instance, since a system for processing signals in α, β, and γ directions of the antenna has the structure in which the system is equipped with an extra relevant module per each sector, whereas the number of the transceiver or high-power amplifier modules used in actuality is 3, the number of the relevant modules grows into 6, including the redundancy structure. Also, because a system for embodying both all three sectors related to the α, β, and γ directions, and 3 FA every each sector is equipped with an extra redundancy module per each sector and per each FA, the number of the transceivers or high-power amplifiers used in actuality is 9, whereas the number of the relevant modules grows into 18, including the redundancy structure.

Hence, as the connection of signal lines becomes complex due to the use of the multiple redundancy modules in the prior RAS system, problems appear in that it is difficult to embody the redundancy structure, and that the expense is very heavy. Namely, the expense increases due to the use of multiple expensive circuit parts, such as the channel cards, the transceivers or the high-power amplifiers, etc., constructing the redundancy modules, and besides, the volume increases when a single frame embeds a number of the redundancy module together with the channel cards, the transceivers or the high-power amplifiers necessarily used in an RAS operated with more than 3 FA and three sectors.

Also, as the number of complex connection signal lines or switches for switching to the redundancy modules between the channel cards and the transceivers or between the transceivers and the high-power amplifiers etc., considerably increases if many redundancy modules are used as in the above, economic feasibility is not satisfied.

Besides, since the carrier frequency band used in communications with the PSS is utilized in order to communicate with the repeater 160 in the prior RAS system, a burden for the frequency up-conversion or down-conversion increases while data is transmitted to the repeater 160 or while data is received from the repeater 160.

### DISCLOSURE OF INVENTION

### Technical Problem

Accordingly, the present invention has been made to solve the above problems occurring in the prior art, and it is an aspect of the present invention to provide a communication method of an RAS for keeping up high-quality services by adding only one redundancy transceiver and only one redundancy high-power amplifier, etc., per a predetermined FA and per a predetermined sector in order to realize simple and economic redundancy, and by using switches for switching to relevant redundancy modules in the case of failures of the important modules in order to operate redundancy efficiently.

It is another aspect of the present invention to provide an RAS system which has an efficient redundancy structure, which facilitates an interface between the RAS system itself and a repeater for expanding service coverage, and which facilitates maintenance/repair in the front access.

Furthermore, it is another aspect of the present invention to provide a communication method of an RAS for maintaining high-quality services and for being capable of expanding service coverage by operating efficient redundancy in preparation for failures of the essential parts and a new scheme of an interface with a repeater.

### Technical Solution

In accordance with one aspect of the present invention, there is provided a Radio Access Station (RAS) system of a Time Division Duplex (TDD) scheme supporting a predetermined number (M) of Frequency Assignments (FAs) and a predetermined number (K) of sectors according to an embodiment of the present invention, comprising: a transceiver unit including an (M×K) number of transceivers and a redundancy transceiver; a high-power amplifying unit including an (M×K) number of high-power amplifiers and a redundancy high-power amplifier; a processor for generating a first switching control signal on sensing a failure of the transceivers and generating a second switching control signal on sensing a failure of the high-power amplifiers; and a Radio Frequency (RF) switch unit for switching a transmission path to the redundancy transceiver and the redundancy high-power amplifier in response to the first switching control signal, and switching a transmission path to the redundancy high-power amplifier in response to the second switching control signal.

In accordance with another aspect of the present invention, there is provided a Radio Access Station (RAS) system of a Time Division Duplex (TDD) scheme supporting a predetermined number (M) of Frequency Assignments (FAs) and a predetermined number (K) of sectors, the RAS system comprising: a channel card unit connected to a router via ethernet-based Layer 2 (L2) switching; a transceiver unit for modulating digital data stream provided from the channel card unit into a transmission Radio Frequency (RF) signal, and for demodulating a received RF signal into digital data stream; a high-power amplifier unit for amplifying a signal modulated by the transceiver unit; and a repeater interface for respectively down-converting signals having the first center frequency received from the channel card unit into baseband signals, respectively up-converting the down-converted signals into signals respectively having the center frequencies different from one another, synthesizing the up-converted signals into one signal, and transmitting the synthesized signal to a repeater.

In accordance with another aspect of the present invention, there is provided a method of communications in a Radio Access Station (RAS) system based on a Time Division Duplex (TDD) scheme supporting a predetermined number (M) of Frequency Assignments (FAs) and a predetermined number (K) of sectors according to an embodiment of the present invention, including the steps of: (A-1) sensing a failure of any one among transceivers and high-power amplifiers; (A-2) connecting a receive path to a redundancy transceiver in a case of sensing a failure of any one among the transceivers; and (A-3) switching a transmission path to the redundancy transceiver and a redundancy high-power amplifier in a case of sensing a failure of any one among the transceivers, and switching a transmission path to the redundancy high-power amplifier in a case of sensing a failure of any one among the high-power amplifiers, wherein the RAS system comprises a transceiver unit including an (M×K) number of the transceivers and the redundancy transceiver; and a high-power amplifying unit including an (M×K) number of the high-power amplifiers and the redundancy high-power amplifier.

In accordance with another aspect of the present invention, there is provided a method of communications in a Radio Access Station (RAS) system based on a Time Division Duplex (TDD) scheme supporting a predetermined number (M) of Frequency Assignments (FAs) and a predetermined number (K) of sectors according to an embodiment of the present invention, including the steps of: (B-1) down-converting signals having the first center frequency respectively received from a channel card unit into baseband signals, respectively; (B-2) up-converting the baseband signals into signals respectively having the center frequencies different from one another, respectively; and (B-3) synthesizing the up-converted signals into one signal, and transmitting the synthesized signal to a repeater, wherein the RAS system comprises the channel card unit, a transceiver unit, a high-power amplifier unit, and a repeater interface.

### Advantageous Effects

Since an RAS system according to the present invention shares one redundancy module per 3 FA/three sectors via RF switches, the RAS system can prepare for failures of the main parts while minimizing an inflow of interference noises, can expand service coverage with economical efficiency as the RAS system can interface per 3 FA with a repeater covering all sectors in three directions, and has the structure in which maintenance/repair can be easily implemented in the front side as a front access board makes a simple connection between cards or between shelves. The RAS system can be embodied so as to be operated simply and economically when the RAS system is applied to a system based on the standards of IEEE 802.16d/e, WiBro, WiMAX, etc.

### BRIEF DESCRIPTION OF THE DRAWINGS

The above and other exemplary features, aspects, and advantages of the present invention will be more apparent from the following detailed description taken in conjunction with the accompanying drawings, in which:

FIG. 1 is a view illustrating a general wireless communication system;

FIG. 2 is a block diagram illustrating a structure of an RAS system according to an embodiment of the present invention;

FIG. 3 is a block diagram showing FIG. 2 in detail in order to illustrate redundancy according to an embodiment of the present invention;

FIG. 4 is a detailed view illustrating a TDD switch unit in FIG. 2 for 4 Receive (4 Rx) diversity according to an embodiment of the present invention;

FIG. 5 is a detailed view illustrating a TDD switch circuit constructing the TDD switch unit shown in FIG. 2;

FIG. 6 is a timing diagram illustrating synchronizing signals associated with an UL and a DL in a TDD system;

FIG. 7 is a view illustrating a first RF Transmission (Tx) switch unit and a second RFTx switch unit shown in FIG. 2;

FIG. 8 is a view illustrating an RF Rx switch unit shown in FIG. 2;

FIG. 9 is a flowchart showing operations of the switches illustrated in FIGS. 7 and 8;

FIG. 10 is a block diagram illustrating in detail an interface of a repeater shown in FIG. 2;

FIG. 11 is a block diagram illustrating a transmission circuit of a logic unit shown in FIG. 10;

FIG. 12 is a block diagram illustrating a receiving circuit of the logic unit shown in FIGS. 10; and

FIG. 13 is a view illustrating an example where units of the RAS system shown in FIG. 2 are partitioned into several shelves and inserted to a frame.

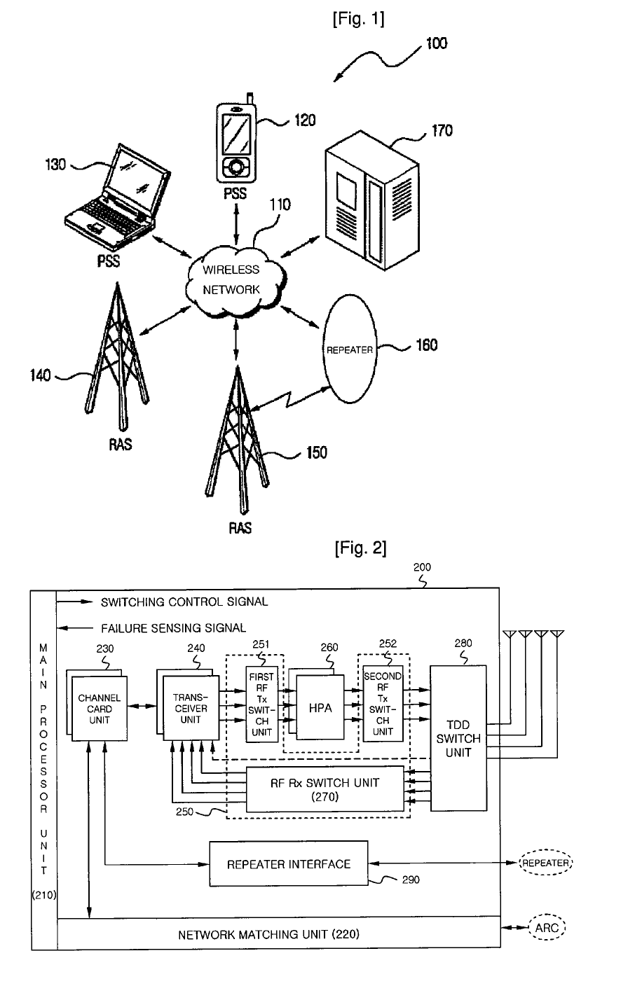

### MODE FOR THE INVENTION

Hereinafter, an exemplary embodiment of the present invention will be described in detail with reference to the accompanying drawings. Well known functions and constructions are not described in detail since they would obscure the invention in unnecessary detail.

FIG. 2 is a block diagram illustrating a structure of an RAS system 200 according to an embodiment of the present invention. With reference to FIG. 2, the RAS system 200 includes a main processor unit 210, a network matching unit 220, a channel card unit 230, a transceiver unit 240, an RF switch unit 250, a high-power amplifier unit 260, a TDD switch unit 280, and a repeater interface 290.

The RAS system 200 can be applied to an RAS system for wireless communications based on the standards of IEEE 802.16d/e, WiBro, WiMAX, etc. Specially, in a portable internet RAS system of the TDD scheme that improves the transfer rate by transmitting data asymmetrically in an DL from an RAS to a PSS and in an UL from the PSS to the RAS, based on an efficient N+1 redundancy structure (herein, ‘N’ represents the number of indispensable channel cards, transceivers or high-power amplifiers) according to the present invention, on an interface with a repeater of a new form, and on a inserting scheme of causing maintenance/repair to be easy in the front access, high-quality services can be maintained and service coverage can be expanded.

The main processor unit 210 controls a general operation of the RAS system 200 as well as a synchronizing clock signal (ONE_PPS) which is based on a Global Positioning System (GPS) as illustrated in FIG. 6. In order to control the DL and the UL, the main processor unit 210 provides synchronizing signals (FRAME_SYNC_1, FRAME_SYNC_2, and FRAME_SYNC_A) necessary for the TDD switch unit 280, the high-power amplifier unit 260, the repeater interface 290, etc., on the basis of a reference synchronizing signal (FRAME_SYNC_R) synchronized with the synchronizing clock signal (ONE_PPS). In FIG. 6, a synchronizing signal FRAME_SYNC_D is generated from the repeater interface 290 on the basis of FRAME_SYNC_A. The use of the synchronizing signals will be described later in more detail in a description of operations of the above units.

Also, for the N+1 redundancy, the main processor unit 210 senses failures in any of channel cards of the channel card unit 230, transceivers of the transceiver unit 240 or high-power amplifiers of the high-power amplifier unit 260, and generates a relevant switching control signals in response to the sensed failures. The main processor unit 210 senses the failures of the channel cards, the transceivers, and/or the high-power amplifiers according to the states of predetermined input/output nodes of the channel c and unit 230, the transceiver unit 240 or the high-power amplifier unit 260. The generated switching control signals, as described later, are provided to the RF switch unit 250, and the RF switch unit 250 causes a relevant failed channel card, transceiver, and/or high-power amplifier to be replaced by a redundancy channel card, transceiver, and/or high-power amplifier.

Meanwhile, for an interface between an Access Control Router (ACR) and the channel card unit 230, the network matching unit 220 supports ethernet-based Layer 2 (L2) switching. Besides, the network matching unit 220 is connected to an environment monitoring device (not shown) or an RAS diagnostic device (not shown), collects the alarm on various kinds of hardware, and can perform the function for reporting the alarm to the main processor unit 210.

The channel card unit 230 is connected to the ACR via the ethernet-based L2 switching in the network matching unit 220. The channel card unit 230 performing a modulator/demodulator (modem) function operates a Media Access Control Layer (MACL) and a PHYsical layer (PHY) for supporting the portable internet, and performs data conversion, i.e. data encoding or decoding, in accordance with protocol among relevant media between the network matching unit 220 and the transceiver unit 240. To take an example, the channel card unit 230 encodes data from the network matching unit 220 by using a predetermined algorithm, and transmits encoded digital data stream to the transceiver unit 240. Also, the channel card unit 230 decodes digital data stream from the transceiver unit 240 by using a predetermined algorithm, and provides the decoded digital data stream to the network matching unit 220.

The transceiver unit 240 modulates the digital data stream from the channel card unit 230 into an RF signal by using a predetermined modulation scheme, i.e. Quadrature Amplitude Modulation (QAM), Quadrature Phase Shift Keying (QPSK), etc., and transmits the RF signal to the high-power amplifier unit 260. Also, the transceiver unit 240 demodulates a received RF signal from the TDD switch unit 280 into a digital data stream by using a predetermined demodulation scheme, and provides the digital data stream to the channel card unit 230.

The high-power amplifier unit 260 amplifies a signal modulated by the transceiver unit 240 into a signal having a predetermined level, and provides the amplified signal to the TDD switch unit 280. Accordingly, the TDD switch unit 280 is connected with antennas for supporting a plurality of sectors (e.g., three sectors), and supports TDD switching.

Especially, the RF switch unit 250 located between the transceiver unit 240 and the TDD switch unit 280 is switched to one redundancy transceiver included in the transceiver unit 240 or one redundancy high-power amplifier included in the high-power amplifier unit 260, in a case where a failure in any of the transceivers included in the transceiver unit 240 or a failure in any of the high-power amplifiers included in the high-power amplifier unit 260 is caused.

To this end, the RF switch unit 250 includes a first RF Tx switch unit 251, a second RF Tx switch unit 252, and an RF Rx switch unit 270. The first RF Tx switch unit 251 is located between the transceiver unit 240 and the high-power amplifier unit 260, and switches to the redundancy transceiver or the redundancy high-power amplifier in a case where a failure in any one among the transceivers included in the transceiver unit 240 is sensed while a signal is transmitted via an antenna. The second RF Tx switch unit 252 is located between the high-power amplifier unit 260 and the TDD switch unit 280, and switches to the redundancy high-power amplifier in a case where a failure in any one among the high-power amplifiers included in the high-power amplifier unit 260 is sensed. The RF Rx switch unit 270 is located between the transceiver unit 240 and the TDD switch unit 280, and switches to the redundancy transceiver in a case where a failure in any one among the transceivers while a signal is received via an antenna is sensed.

The repeater interface 290 is connected to the channel card unit 230, and supports a predetermined FA interface (e.g., 3 FA) between a repeater having an omnidirectional antenna covering the plurality of sectors (e.g., three sectors) and the channel card unit 230. Accordingly, the repeater interface 290 can relay so that enough signal sensitivity may be maintained between the RAS system and PSSes. Above all, as mentioned later, the repeater interface 290 communicates with the channel card unit 230 and the repeater by using the Intermediate Frequency (IF) between a baseband and the carrier frequency, can reduces overhead which caused by the frequency conversion.

FIG. 3 is a block diagram showing FIG. 2 in detail in order to illustrate redundancy according to an embodiment of the present invention.

Referring to FIG. 3, the channel card unit 230, the transceiver unit 240, and the high-power amplifier unit 260 in order to support the 3 FA and the three sectors (i.e., α, β, and γ are equipped with nine channel cards (the channel cards #1 to #9), nine transceivers (the transceivers #1 to #9), and nine high-power amplifiers (the high-power amplifiers #1 to #9), respectively, and further include a redundancy channel card 232, a redundancy transceiver 242, and a redundancy high-power amplifier 262, respectively. More specifically, for redundancy, the channel card 232, the transceiver 242, and the high-power amplifier 262 are respectively prepared in the units 230, 240, and 260, together with a first set including the three channel cards #1 to #3 for processing 3 FA frequencies (the center frequencies: f1, f2, and f3) of the α sector, the three transceivers #1 to #3, and the three high-power amplifiers #1 to #3, a second set including the three channel cards #4 to #6 for processing 3 FA frequencies of the β sector, the three transceivers #4 to #6, and the three high-power amplifiers #4 to #6, and a third set including the three channel cards #7 to #9 for processing 3 FA frequencies of the γ sector, the three transceivers #7 to #9, and the three high-power amplifiers #7 to #9. For instance, apart from the nine channel cards #1 to #9 included in the channel card unit 230, an additional redundancy channel card 232 is prepared per the 3 FA and the three sectors, aside from the nine transceivers #1 to #9 included in the transceivers unit 240, an additional redundancy transceiver 242 is prepared per the 3 FA and the three sectors and besides the nine high-power amplifiers #1 to #9 included in the high-power amplifier unit 260, an additional redundancy high-power amplifier 262 per the 3 FA and the three sectors 262 is prepared. Herein, even though the description has been made to cite the RAS system for supporting the 3 FA and the three sectors as an example, the present invention is not limited to this, and it is apparent to one skilled in the art that additional preparation of a redundancy configuration per M (i.e., the number of FAs equal to or more than three) and per K (i.e., the number of sectors equal to or more than three) can be applied to an RAS system supporting a scheme of N (here, N=M×K)+1. Herein, N=M×K is equal either to the number of indispensable channel cards, to the number of indispensable transceivers, or to the number of indispensable high-power amplifiers.

In FIG. 3, in a case where a failure occurs in any one among the nine transceivers #1 to #9 with which the transceiver unit 240 is equipped, the main processor unit 210 generates a switching control signal on sensing the failure of the relevant transceiver, and provides the switching control signal to the first RF Tx switch unit 251. The first RF Tx switch unit 251 disconnects the relevant failed transceiver in response to the switching control signal, switches to the redundancy transceiver 242 of the transceiver unit 240 according to the switching control signal from the main processor unit 210, and makes a connection with the relevant high-power amplifier with which the high-power amplifier unit 260. Herein, the main processor unit 210 senses a failure even in a case where the relevant transceiver malfunctions as an operation of any one among the channel cards of the channel card unit 230 is not normal. To take an instance, while the first transceiver and the first high-power amplifier perform a normal operation in a state where the first transceiver (i.e., the transceiver #1) of the transceiver unit 240 and the first high-power amplifier (i.e., the high-power amplifier #1) of the high-power amplifier unit 260 are connected, if a failure in the first transceiver (i.e., the transceiver #1) of the transceiver unit 240 occurs, the redundancy transceiver 242 of the transceiver unit 240 operates in place of the first transceiver (i.e., the transceiver #1) by an switching operation of the first RF Tx switch unit 251, and an output of the redundancy transceiver 242 is transmitted to the relevant high-power amplifier of the high-power amplifier unit 260. In a case where the redundancy transceiver 242 of the transceiver unit 240 operates, the redundancy channel card 232, corresponding to the redundancy transceiver 242, of the channel card unit 230 operates in substitute for the relevant channel card corresponding to the failed transceiver.

Also, in a case where a failure occurs in any one among the nine high-power amplifiers #1 to #9 with which the high-power amplifier unit 260 is equipped, the main processor unit 210 generates a switching control signal on sensing a failure of the relevant high-power amplifier, and provides the switching control signal to the second RF Tx switch unit 252. The second RF Tx switch unit 252 disconnects the relevant failed high-power amplifier in response to the switching control signal, switches to the redundancy high-power amplifier 262 of the high-power amplifier unit 260 according to the switching control signal of the main processor unit 210, and is connected to a relevant TDD switch with which the TDD switch unit 280 is equipped. For example, while the second transceiver and the second high-power amplifier perform a normal operation in a state where the second transceiver (i.e., the transceiver #2) of the transceiver unit 240 and the second high-power amplifier (i.e., the high-power amplifier #2) of the high-power amplifier unit 260 are connected, if a failure occurs in the second high-power amplifier (i.e., the high-power amplifier #2) of the high-power amplifier unit 260, the redundancy high-power amplifier 262 of the high-power amplifier unit 260 operates in place of the second high-power amplifier (i.e., the high-power amplifier #2) by an switching operation of the second RF Tx switch unit 252, an output of the second transceiver (i.e., the transceiver #2) of the transceiver unit 240 is transmitted to the redundancy high-power amplifier 262 of the high-power amplifier unit 260. Accordingly, the redundancy high-power amplifier 262 of the high-power amplifier unit 260 is connected with a relevant TDD switch with which the TDD switch unit 280 is equipped.

Also, on a receive path, in a case where a failure occurs in any one of among the nine transceivers #1 to #9 with which the transceiver unit 240 is equipped, the main processor unit 210 generates a switching control signal on sensing the failure of the relevant transceiver, and provides the switching control signal to the RF Rx switch unit 270. The RF Rx switch unit 270 disconnects the relevant failed transceiver in response to the switching control signal, switches to the redundancy transceiver 242 of the transceiver unit 240 according to the switching control signal of the main processor unit 210, and makes a connection with a relevant TDD switch with which the TDD switch unit 280 is equipped. To give an example, while the third transceiver and a relevant TDD switch perform a normal operation in a state where the third transceiver (i.e., the transceiver #3) of the transceiver unit 240 and the relevant TDD switch included in the TDD switch unit 280 are connected, if a failure occurs in the third transceiver (i.e., the transceiver #3) of the transceiver unit 240, the redundancy transceiver 242 of the transceiver unit 240 operates in substitute for the third transceiver (i.e., the transceiver #3) by switching of the RF Rx switch unit 270, and an output of the relevant TDD switch included in the TDD switch unit 280 is transmitted to the redundancy transceiver 242 of the transceiver unit 240. In a case where the redundancy transceiver 242 of the transceiver unit 240 operates, the redundancy channel card 232, corresponding to the redundancy transceiver 242, of the channel card unit 230 operates in place of the relevant channel card corresponding to the failed transceiver.

Herein, each of the transceivers #1 to #9 and R of the transceiver unit 240 receives, from the TDD switch unit 280, four similar signals corresponding with any one among the sectors (i.e., α, β, and γ in order to support the 4 Receive (Rx) diversity.

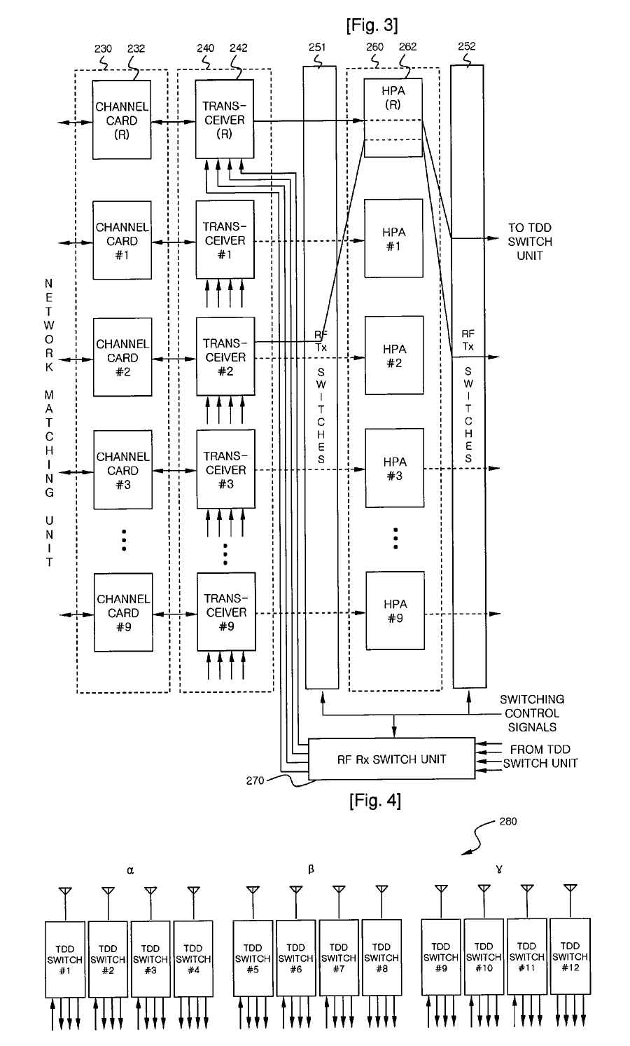

FIG. 4 is a detailed view illustrating a TDD switch unit in FIG. 2 for 4 Rx diversity according to an embodiment of the present invention. With reference to FIG. 4, the TDD switch unit 280 includes TDD switches #1 to #12 respectively connected to antennas per each of the three sectors α, β, and γ on a four-by-four basis, and each of the TDD switches #1 to #12 transmits four copied receive signals for the 4 Rx diversity to the four transceivers of the transceiver unit 240.

Each of the TDD switches #1 to #12 selectively transmits a transmission signal of a relevant high-power amplifier according to a predetermined synchronizing signal of the main processor unit 210 by using a circulator, or receives a signal input through the antenna. A Low Noise Amplifier (LNA) can be used while receiving the signal, and the four received signals copied by the LNA can be respectively transmitted to four transceivers of the transceiver unit 240 supporting the 4 Rx diversity via the RF Rx switch unit 270. Herein, the circulator is a sort of isolator that transmits an input signal in only one direction without attenuation whereas isolating a signal inversely flowing into the circulator 510. Namely, in order to isolate the signal inversely flowed from a subsequent circuit or an antenna, etc. when a high-energy signal outputting from each high-power amplifier of the high-power amplifier unit 260 flows into the circulator 510, an isolation switch manufactured by using a ferrite substance having high coercivity can be used as the circulator 510.

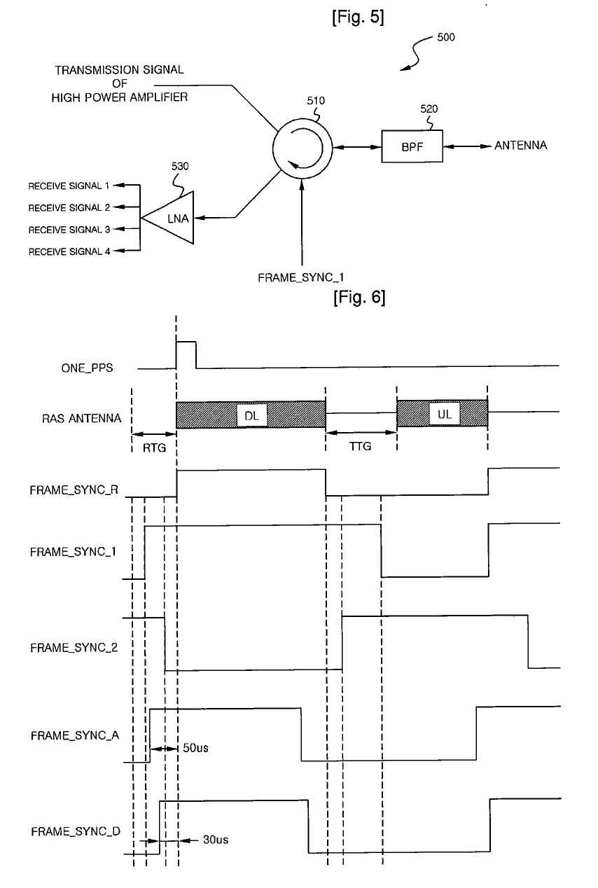

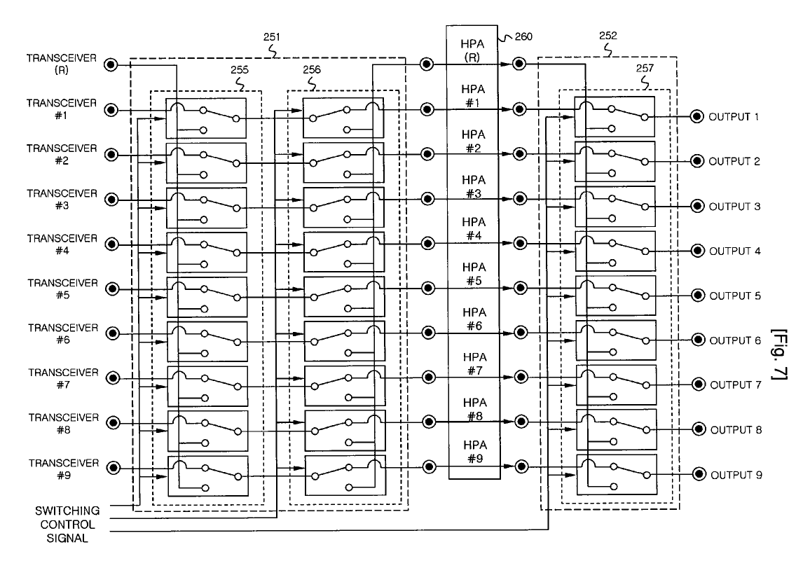

An example of a TDD switch circuit 500 constructing the TDD switch unit 280 shown in FIG. 2 is illustrated in FIG. 5. With reference to FIG. 5, the TDD switch circuit 500 includes a circulator 510, a Band-Pass Filter (BPF), and an LNA 530.

On the basis of the synchronizing signal (FRAME_SYNC_1), the circulator 510 selectively transmits a transmission signal of the relevant high-power amplifier or transmits a receive signal received from the BPF 520 to the LNA 530. The circulator 510 takes charge of isolator that transmits an input signal in only one direction without attenuation whereas isolating a signal inversely flowing into the circulator 510. Namely, in order to isolate the signal inversely flowing from a subsequent circuit or an antenna, etc. when high-energy signals outputting from the high-power amplifier unit 260 flows into the circulator 510, an isolation switch manufactured by using a ferrite substance having high coercivity can be used as the circulator 510.

The BPF 520 is connected between any relevant one among the antennas and a path through which an output of the circulator 510 is transmitted. The LNA 530 amplifies a signal received by the circulator 510 by way of the relevant antennal and the BPF 520. Four receive signals copied by the LNA 530 are transmitted to the transceiver unit 240 supporting the 4 Rx diversity via the RF Rx switch unit 270.

As illustrated in FIG. 6, the TDD switch circuit 500 transmits a transmission signal provided from the high-power amplifier unit 260 or receives a signal through the LNA 530 during an DL and an UL separately according to the TDD scheme, and switches based on the synchronizing signal (FRAME_SYNC_1) of the main processor unit 210. At this time, the main processor unit 210 generates the synchronizing signal (FRAME_SYNC_1) before the DL in consideration of delay on a path or ramp up/down time of the high-power amplifiers. The TDD switch circuit 500 is controlled to disconnect the receive signal and to transfer only the transmission signal during the DL, whereas being controlled to disconnect the transmission signal and to input only the receive signal during the UL. Then, when the synchronizing signal (FRAME_SYNC_2) is activated during the UL, the amplifiers of the high-power amplifier unit 260 is OFF so as to establish isolation between a transmission path and a receive path, which prevents noises caused by interference between the transmission signal and the receive signal from flowing inward.

Hereinafter, a description will be more specifically made of the first RF Tx switch unit 251 and the second RF Tx switch unit 252, and the RF Rx switch unit 270.

For starters, a view illustrating the first RF Tx switch unit 251 and the second RF Tx switch unit 252 shown in FIG. 2 is illustrated in FIG. 7.

Referring to FIG. 7, the first RF Tx switch unit 251 includes at least two first switches 255 and at least two second switches 256, and the second RF Tx switch unit 252 includes at least two third switches 257.

While all transceivers #1 to #9 of the transceiver unit 240 operate normally, the first switches 255 transmit outputs of the transceivers #1 to #9 to the second switches 256 respectively corresponding with the first switches 255 by the switching control signals from the main processor unit 210. In a case where a failure occurs in any one (e.g., the transceiver #1) among the transceivers #1 to #9, the relevant switch among the first switches 255 connected with the failed transceiver is disconnected with the failed transceiver in response to a first switching control signal of the main processor unit 210, is switched to the redundancy transceiver (R), and transmits an output of the redundancy transceiver (R), instead of an output of the failed transceiver, to the relevant switch (e.g., the switch connected to the transceiver #1 in a normal state) among the second switches 256.

Also, the relevant switch among the second switches 256 connected with the redundancy transceiver (R) due to the occurrence of a failure in the transceiver unit 240, is switched to the redundancy high-power amplifier (R) in response to the first switching control signal of the main processor unit 210 regardless of whether the high-power amplifier unit 260 is defective, and then, the switching is performed so that a relevant switch (e.g., the switch connected to the high-power amplifier #1 in a normal state) among the third switches 257 may also be connected to the redundancy high-power amplifier (R).

In this manner, the first switching control signal from the main processor unit 210, necessary to control the first switches 255, the second switches 256, and the third switches 257 in preparation for the failure occurrence in the transceiver unit 240 can be the form of digital data (A4 to A1) as in TABLE 1. For instance, in a case where all the transceivers #1 to #9 are in a normal state without failures, the digital data A4 to A1 can be ‘0000’. However, when a failure of any one among the transceivers #1 to #9 occurs, the digital data A4 to A1 changes as in TABLE 1, and accordingly, the switches 255, 256, and 257 operates for transmitting an output of the redundancy transceiver (R), in substitute for the relevant failed module, to the relevant TDD switch through the redundancy high-power amplifier (R).

TABLE 1

| A4 | A3 | A2 | A1 | transceiver states |
|---|---|---|---|---|
| 0 | 0 | 0 | 0 | transceivers #1 to #9: all normal |
| 0 | 0 | 0 | 1 | transceiver #1: failed |
| 0 | 0 | 1 | 0 | transceiver #2: failed |
| 0 | 0 | 1 | 1 | transceiver #3: failed |
| 0 | 1 | 0 | 0 | transceiver #4: failed |
| 0 | 1 | 0 | 1 | transceiver #5: failed |
| 0 | 1 | 1 | 0 | transceiver #6: failed |
| 0 | 1 | 1 | 1 | transceiver #7: failed |
| 1 | 0 | 0 | 0 | transceiver #8: failed |
| 1 | 0 | 0 | 1 | transceiver #9: failed |

To cite an instance, while both the first transceiver (the transceiver #1) of the transceiver unit 240 and the first high-power amplifier (the high-power amplifier #1) of the high-power amplifier unit 260 operate normally in a state where the first transceiver and the first high-power amplifier are interconnected via the first switches 255 and the second switches 256, if a failure occurs in the first transceiver (the transceiver #1) of the transceiver unit 240, the main processor unit 210 generates digital data A4 to A1 of ‘0001’ as a switching control signal according to TABLE 1. Accordingly, the relevant switch among the first switches 255 connected with the failed first transceiver (the transceiver #1) is disconnected with the first transceiver (the transceiver #1), is switched to the redundancy transceiver (R), and transmits the output of the redundancy transceiver (R) to the switch connected with the first transceiver (the transceiver #1) among the second switches 256 in a normal state.

At this time, the relevant switch connected to the redundancy transceiver (R) among the second switches 256 is also switched to the redundancy high-power amplifier (R) according to the digital data A4 to A1 irrespective of whether the high-power amplifier unit 260 is erroneous. In addition, the switch connected to the first high-power amplifier (the high-power amplifier #1) among the third switches 257 in a normal state is also switched to the redundancy high-power amplifier (R) according to the digital data A4 to A1 so that an output of the redundancy high-power amplifier (R) may be connected to the switch.

Likewise, even when the failure(s) occur(s) in the second to the ninth transceivers (the transceivers #2 to #9) of the transceiver unit 240, the operation is performed like the preceding.

The digital data A4 to A1 from the main processor unit 210 is directly input to the switches 255, 256, and 257, and can perform the above path switching with a relevant internal logic. Still, without being limited to this, the digital data A4 to A1 is processed in a predetermined logic, is converted into predetermined selection signals for switching paths of the switches 255, 256, and 257, and can also be input to the switches 255, 256, and 257, respectively.

Meanwhile, while all high-power amplifiers #1 to #9 of the high-power amplifier unit 260 operate normally, the second switches 256 transmit outputs of the first switches 255 to the high-power amplifiers #1 to #9 respectively corresponding with the second switches 256 via the second switches 256 by the switching control signals from the main processor unit 210. In a case where a failure occurs in any one (e.g., the high-power amplifier #1) among the high-power amplifiers #1 to #9, the relevant switch connected to the failed high-power amplifier among the second switches 256 is disconnected with the failed high-power amplifier in response to the second switching control signal of the main processor unit 210, is switched to the redundancy high-power amplifier (R), and provides an output of the relevant switch among the second switches 256 to the redundancy high-power amplifier (R) instead of the failed high-power amplifier. Then, an output of the redundancy high-power amplifier (R) is transmitted to the relevant switch (e.g., the switch connected with the high-power amplifier #1 in a normal state) among the third switches 257.

At this time, the relevant switch among the third switches 257 receiving the output from the redundancy high-power amplifier (R) due to the failure occurrence in the high-power amplifier unit 260 also responds to the second switching control signal from the main processor unit 210, and is switched so that the output of the redundancy high-power amplifier (R) may be connected to a relevant TDD switch.

In this manner, the second switching control signal from the main processor unit 210, necessary to control the second switches 256 and the third switches 257 in preparation for the failure occurrence in the high-power amplifier unit 260, can be the form of digital data (B4 to B1) as in TABLE 2. For instance, in a case where all the high-power amplifiers #1 to #9 are in a normal state without failures, the digital data B4 to B1 can be ‘0000’. However, when a failure of any one among the high-power amplifiers #1 to #9 occurs, the digital data B4 to B1 changes as in TABLE 2, and accordingly the switches 256 and 257 operate for transmitting an output of the redundancy high-power amplifier (R), in substitute for the relevant failed module, to the relevant TDD switch.

TABLE 2

| B4 | B3 | B2 | B1 | high-power amplifier states |
|---|---|---|---|---|
| 0 | 0 | 0 | 0 | all high-power amplifiers #1 to #9 are normal |
| 0 | 0 | 0 | 1 | high-power amplifier #1: failed |
| 0 | 0 | 1 | 0 | high-power amplifier #2: failed |
| 0 | 0 | 1 | 1 | high-power amplifier #3: failed |
| 0 | 1 | 0 | 0 | high-power amplifier #4: failed |
| 0 | 1 | 0 | 1 | high-power amplifier #5: failed |
| 0 | 1 | 1 | 0 | high-power amplifier #6: failed |
| 0 | 1 | 1 | 1 | high-power amplifier #7: failed |
| 1 | 0 | 0 | 0 | high-power amplifier #8: failed |
| 1 | 0 | 0 | 1 | high-power amplifier #9: failed |

Meanwhile, as described above, when a failure occurs in any one of the transceivers #1 to #9 of the transceiver unit 240, all of the first switches 255, the second switches 256, and the third switches 257 switch according to TABLE 1, whereas only the second switches 256 and only the third switches 257 switch according to TABLE 2, and the first switches 255 are not switched but keep up a previous state, when a failure occurs in any one among the high-power amplifiers #1 to #9 of the high-power amplifier unit 260. This is why failure probability of the high-power amplifier is relatively high then the transceiver. Namely, if a normal transceiver or a normal channel card is switched even when the failure(s) occur(s) in the high-power amplifier, this causes a of services to increase from a standpoint of maintenance/repair. In this manner, in the present invention, the redundancy of the high-power amplifier unit 260 is put in practice independently of the N+1 redundancy of the channel card unit 230 or the transceiver unit 240.

For example, while the high-power amplifier unit 260 operates normally, if a failure occurs in the first high-power amplifier (the high-power amplifier #1), the main processor unit 210 generates the digital data B4 to B1 of ‘0001’ as switching control signals according to TABLE 2. Accordingly, the relevant switch connected to the failed first high-power amplifier (the high-power amplifier #1) among the second switches 256 is disconnected with the first high-power amplifier (the high-power amplifier #1), is switched to the redundancy high-power amplifier (R), and transmits an output of the relevant switch among the second switches 256 to the redundancy high-power amplifier (R). Then, an output of the redundancy high-power amplifier (R) is transmitted to the switch connected with the high-power amplifier #1 in a normal state among the third switches 257.

At this time, the relevant switch, among the third switches 257 receiving the output from the redundancy high-power amplifier (R) due to the failure occurrence in the high-power amplifier unit 260, is also switched according to the digital data B4 to B1 so that the output of the redundancy high-power amplifier (R) may be connected to a relevant TDD switch.

Likewise, even when failure(s) occur(s) in the second to the ninth high-power amplifiers (the high-power amplifiers #2 to #9) of the high-power amplifier unit 260, the operation is performed like the preceding.

The digital data B4 to B1 from the main processor unit 210 is also directly input to the switches 256 and 257, and can perform the above path switching with a relevant internal logic. Still, without being limited to this, the digital data B4 to B1 is processed in a predetermined logic, is converted into predetermined selection signals for switching paths of the switches 256 and 257, and can also be input to the switches 256 and 257, respectively.

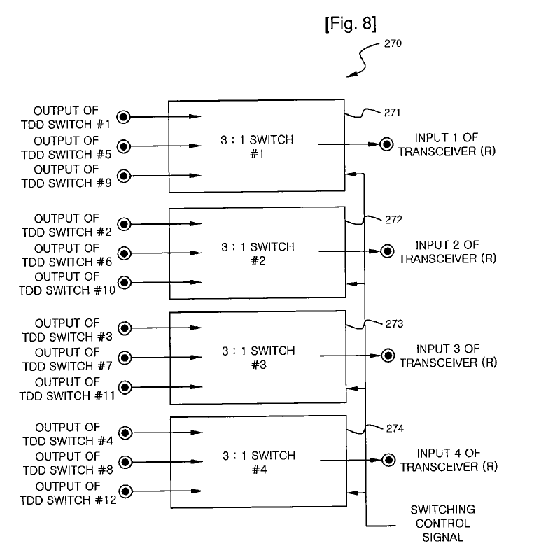

A view illustrating the RF Rx switch unit 270 shown in FIG. 2 is illustrated in FIG. 8. As illustrated in FIG. 8, the RF Rx switch unit 270 includes at least two switches 271 to 274.

While all of the transceivers #1 to #9 of the transceiver unit 240 normally operate on a receive path, all input/output ports of the switches 271 to 274 do not operate by the switching control signals from the main processor unit 210. At this time, all input/output ports of the switches 271 to 274 can be in a floating state.

In a case where a failure occurs in any one (e.g., the transceiver #1) among the transceivers #1 to #9, the switches 271 to 274 transmits outputs corresponding to any one relevant sector (α, β, or γ) among receive signals from the TDD switches #1 to #12 to the redundancy transceiver (R) instead of the relevant failed transceiver in response to the switching control signal of the main processor unit 210.

A third switching control signal from the main processor unit 210, necessary to control the switches 271 to 274 in preparation for the failure occurrence of the transceiver unit 240 on the receive path in this manner, can be the form of digital data C2 and C1 as in TABLE 3. To give an instance, in a case where the transceivers #1 to #9 are all in a normal state without failures, the digital data C2 and C1 can be ‘00’. However, when a failure occurs in any one among the transceivers #1 to #9, the digital data C2 and C1 changes as in TABLE 3, and accordingly, the switches 271 to 274 operate for transmitting an output of the TDD switch of the relevant sector (α, β, or γ) to the redundancy transceiver (R) in substitute for the relevant failed module.

Herein, the switches 271 to 274 include four 3:1 switches for transmitting four copied outputs received by each of the relevant TDD switches via antennas corresponding with each of the relevant sectors α, β, and γ to the redundancy transceiver (R) to be substituted for the failed module in order to process a relevant sector of the failed module. Namely, each of the switches 271 to 274 receives, on a three-by-three basis, signals from each of the three sectors among signals received via twelve antennas for supporting the three sectors and the 4 Rx diversity, and outputs, to the redundancy transceiver (R), any one signal selected among the received three signals according to digital data C2 and C1 as in TABLE 3.

TABLE 3

| C2 | C1 | switch states |
|---|---|---|
| 0 | 0 | all ports stop their operations |
| 0 | 1 | switch to α path |
| 1 | 0 | switch to β path |
| 1 | 1 | switch to γ path |

Herein, a selection of a signal depends on a sector where a relevant failed module processes. For instance, the transceivers #1 to #3 for supporting the 3 FA can process signals of the α sector, the transceivers #4 to #6 for supporting the 3 FA can process signals of the β sector, and the transceivers #7 to #9 for supporting the 3 FA can process signals of the γ sector.

To cite an example, if a receive failure occurs in the first transceiver (the transceiver #1) while the transceiver unit 240 normally operates, the main processor unit 210 generates the digital data C2 and C1 of ‘01’ as switching control signals according to TABLE 3. Hence, the switches 271 to 274 transmit outputs related to any one relevant sector (α, β, or γ) among the receive signals from the TDD switches #1 to #12 to the redundancy transceiver (R) instead of the relevant failed transceiver (the transceiver #1). A selection of a signal in the switches 271 to 274 depends on a sector that the first transceiver (the transceiver #1) processes. To take an instance, if the first transceiver (the transceiver #1) has processed the signals of the α sector, the switches 271 to 274 transmit, to the redundancy transceiver, signals of the α sector among the receive signals from the TDD switches #1 to #12 according to the digital data C2 and C1 of ‘01’.

Similarly, even when receive failure(s) occur(s) in the second to the ninth transceivers (the transceivers #2 to #9) of the transceiver unit 240, the operation is performed like the preceding.

Herein, the digital data C2 and C1 from the main processor unit 210 is also directly input to the switches 271 and 274, and can perform the above path switching with an internal logic of the switches 271 to 274. Still, without being limited to this, the digital data C2 to C1 is also processed in a predetermined logic, is converted into predetermined selection signals for switching paths of the switches 271 and 274, and can also be input to the switches 271 and 274, respectively.

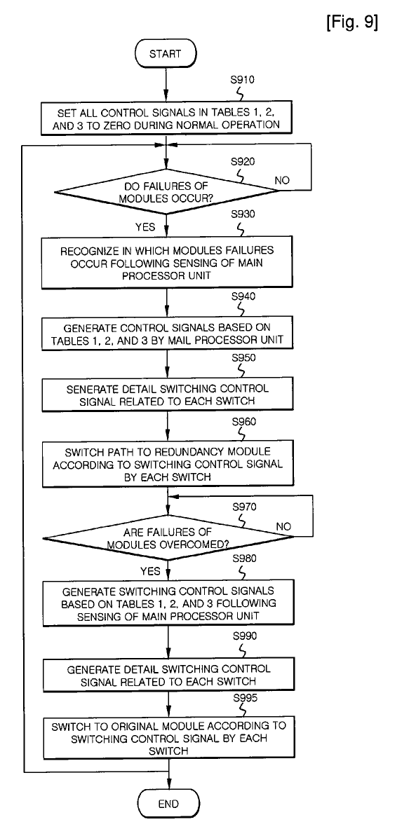

Hereinafter, with reference to a flowchart illustrated in FIG. 9, operations of the switches shown in FIGS. 7 and 8 will be described in more detail. First, if all modules with which the channel card unit 230, the transceiver unit 240, and the high-power amplifier unit 260 are included, are normal, as in TABLEs 1, 2, and 3, the digital data from the main processor unit 210 are all set to ‘0. ’ (i.e., ‘0000’ or ‘00’) (S910). At this time, if a failure occurs even in any one module among the nine channel cards #1 to #9 included in the channel card unit 230, the nine transceivers #1 to #9 included in the transceiver unit 240, and the nine high-power amplifiers #1 to #9 included in the high-power amplifier unit 260 (S920), the main processor unit 210 senses the failure occurrence, recognizes which module(s) correspond(s) to the failed module(s) (S930), and generates digital switching control signals according to TABLEs 1, 2, and 3 (S940).

Even though the switches 255, 256, and 257 can perform switching as in the illustrations of FIGS. 5 and 6 by the digital switching control signal from the main processor unit 210, in a case where the above switches 255, 256, and 257 is configured of circuits for simply performing switching by predetermined selection signals for detail switchings, a prescribed logic can be used in order to change the digital switching control signals provided from the main processor unit 210 to the selection signals (S950).

If the main processor unit 210 generates the switching control signals in this manner, the switches 255, 256, and 257 switch paths so as to replace the relevant failed module with the redundancy module (S960). For instance, in a case where a failure occurs in any one transceiver with which the transceiver unit 240 is equipped, regardless of whether or not failures of the high-power amplifier unit 260 occurs, the first and second switches 255 and 256 are switched so that an output of the redundancy transceiver (R) may be transmitted to the redundancy high-power amplifier (R) via the first and second switches 255 and 256, and the third switch 257 is switched so that an output of the redundancy high-power amplifier (R) may be transmitted to the relevant TDD switch via the third switch 257. Also, in a case where a failure occurs in any one high-power amplifier with which the high-power amplifier unit 260 is equipped, an output of a relevant switch connected to the failed high-power amplifier among the second switches 256 is switched to the redundancy high-power amplifier (R), and at this time, an output of the redundancy high-power amplifier (R) is provided to the relevant TDD switch via a relevant switch among the third switches 257.

The path switching states of the switches 255, 256, and 257 continue as long as the failures are not solved, and if the failed module is replaced by a normal module or if causes of the failures are removed (S970), the main processor unit 210, as above, generates a switching control signal, e.g., a digital data value of ‘0000’ or ‘00,’ meaning a case where all become normal according to TABLEs 1, 2, and 3 (S980). Accordingly, a prescribed logic can generate predetermined selection signals for detail switching of the switches 255, 256, and 257 (S990), and the switches 255, 256, and 257 can change over to modules of the original numbers before the failure occurrence (S995).

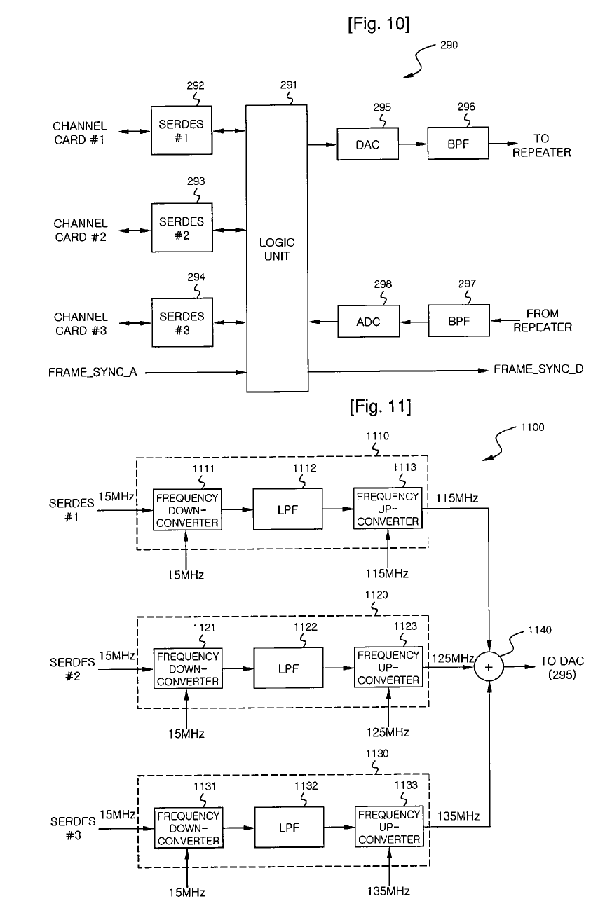

Meanwhile, a specific view of the repeater interface 290 shown in FIG. 2 is illustrated in FIG. 10. Referring to FIG. 10, the repeater interface 290 includes a logic unit 291, Serializer/Deserializeres (SerDeses) 292 to 294, a Digital-to-Analog Converter (DAC) 295, BPFs 296 and 297, an Analog-to-Digital Converter (ADC) 298.

The logic unit 291 is connected to the channel card unit 230 through the SerDeses 292 to 294, and supports the 3 FA interface between a repeater having an omnidirectional antenna covering the three sectors and the channel card unit 230.

The logic unit 291 receives an IF signal having a certain center frequency from each of three cards for the 3 FA in the channel card unit 230, and converts the frequency of the received IF signal. Then, the logic unit 291 sums up converted IF signals. To cite an instance, the IF signal from the channel card unit 230 can be an IF signal having the center frequency of 10 [MHz] to 20 [MHz], and more desirably, can be an IF signal having the center frequency of about 15 [MHz]. Also, in relation to the signals having the converted frequencies, the frequency range of the 3 FA desirably lies from 111 [MHz] to 138 [MHz], where it is desirable that a first FA lies from 111 [MHz] to 120 [MHZ], a second FA lies from 121 [MHz] to 130 [MHz], and a third FA lies from 131 [MHz] to 138 [MHz]. The first to the third FA are more desirably converted in frequency so that a difference between the center frequencies may be about 9 to 10 [MHz]. The signals whose frequencies have been converted in this manner are transmitted to the repeater via the DAC 295 and the BPF 296.

In addition, the logic unit 291 separates three frequency signals for the 3 FA from a communication signal having the center frequency of about 75 [MHz] received from the repeater via the BPF 297 and the ADC 298, converts three separated signals into signals, all having the center frequency of 15 [MHz], and provides the three separated signals to the three channel cards for the 3 FA in the channel card unit 230, respectively.

FIG. 11 is a block diagram illustrating a transmission circuit 1100 of the logic unit 291 shown in FIG. 10. With reference to FIG. 11, the transmission circuit 1100 includes multiple transmission frequency converters 1110, 1120 and 1130, and a frequency synthesizer 1140. The transmission frequency converter 1110 includes a frequency down-converter 1111, an LPF 1112, and a frequency up-converter 1113. The transmission frequency converter 1120 includes a frequency down-converter 1121, an LPF 1122, and a frequency up-converter 1123. The transmission frequency converter 1130 includes a frequency down-converter 1131, an LPF 1132, and a frequency up-converter 1133.

To take an instance, while a signal having the center frequency of 15[MHz] from any one card of the channel card unit 230 is received from the SerDes #1 292, the frequency down-converter 1111 down-converts the received signal into a baseband signal by using a down-conversion oscillation signal of 15 [MHz]. Accordingly, the LPF 1112 filters the baseband signal, and the frequency up-converter 1113 up-converts a filtered baseband signal into an up-converted digital signal by using an up-conversion oscillation signal of 115 [MHz].

In the way similar to this, if the transmission frequency converters 1120 and 1130 generates two signals whose frequencies are respectively up-converted into 25 and 35 [MHz], from signals all having the center frequency of 15 [MHz] provided from the other two cards of the channel card unit 230, received from the SerDeses #2 and #3 292 and 293, the three signals whose frequencies have been respectively up-converted into frequencies having a difference between the center frequencies of 10 [MHz], provided from the multiple transmission frequency converters 1110, 1120 and 1130, are summed by the frequency synthesizer 1140. Thereafter, a composite signal is converted from a digital signal into an analog signal by the DAC 295, and the composite analog signal is transmitted to the repeater via the BPF 296.

As illustrated in FIG. 10, the logic unit 291 receives a synchronizing signal (FRAME_SYNC_A) from any one card of the channel card unit 230, adjusts the received synchronizing signal, and can provide, to the repeater, a synchronizing signal (FRAME_SYNC_D) adjusted from the received synchronizing signal. The synchronizing signal (FRAME_SYNC_A) is a signal activated at a point in time earlier than the reference synchronizing signal (FRAME_SYNC_R) by estimating in advance the maximum distance by which the repeater is to be installed in a position off a reference point, and accordingly, considering the maximum delay time. The logic unit 291 adjusts timing of the synchronizing signal (FRAME_SYNC_A) to the purpose with the distance by which the repeater is actually installed off a reference point, and can generates a synchronizing signal having adjusted timing to the repeater. For instance, in a case where a transmission delay of 5 [μs/km] is caused in the repeaters interconnected with optical fiber, for the repeater located in a position 10 [km] off a reference point predicted to be the maximum distance, the channel card can generates the synchronizing signal (FRAME_SYNC_A) activated at a point in time earlier by 50 [μs] than the reference synchronizing signal (FRAME_SYNC_R) as in FIG. 6, and accordingly, the logic unit 291 of the repeater interface 290 controls timing with a synchronizing signal (FRAME_SYNC_D) activated at a point in time earlier by 30 [μs] than the reference synchronizing signal (FRAME_SYNC_R), according to an actual distance by which the repeater is to be installed in a position off a reference point, so that synchronizing problem caused by installation of the repeater can be overcome.

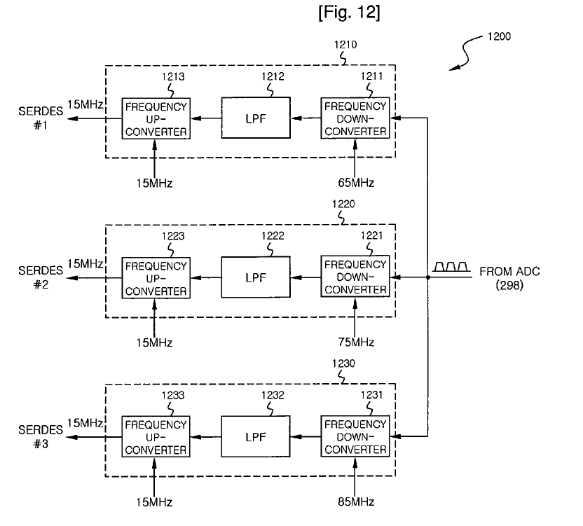

FIG. 12 is a block diagram illustrating a receiving circuit 1200 of the logic unit 291 shown in FIG. 10. With reference to FIG. 12, the receiving circuit 1200 includes multiple receive frequency converters 1210, 1220, and 1230. The receive frequency converter 1210 includes a frequency down-converter 1211, an LPF 1212, and a frequency up-converter 1213. The receive frequency converter 1220 includes a frequency down-converter 1221, an LPF 1222, and a frequency up-converter 1223. The receive frequency converter 1230 includes a frequency down-converter 1231, an LPF 1232, and a frequency up-converter 1233.

For example, the frequency down-converter 1211 down-converts a communication signal having the center frequency of 125 [MHz] received from the repeater via the BPF 297 and the ADC 298 into a baseband signal by using a down-conversion oscillation signal of 65 [MHz]. Accordingly, the LPF 1212 filters the baseband signal, and the frequency up-converter 1213 up-converts a filtered baseband signal into an upconverted digital signal by using an up-conversion oscillation signal of 15 [MHz].

In the way similar to this, the receive frequency converters 1220 and 1230 all receive a communication signal having the center frequency of 125 [MHz] received from the repeater via the BPF 297 and the ADC 298, down-convert the received communication signals into baseband signals by using different down-conversion oscillation signals having 75 [MHz] and 85 [MHz], respectively, and respectively upconvert the two baseband signals into two up-converted signals all having 15 [MHz]. Then, the up-converted three signals, all having the center frequency of 15 [MHz], provided from the receive frequency converters 1210, 1220, and 1230, are transmitted to the three cards of the channel card unit 230 from three SerDeses #1, #2, and #3, respectively.

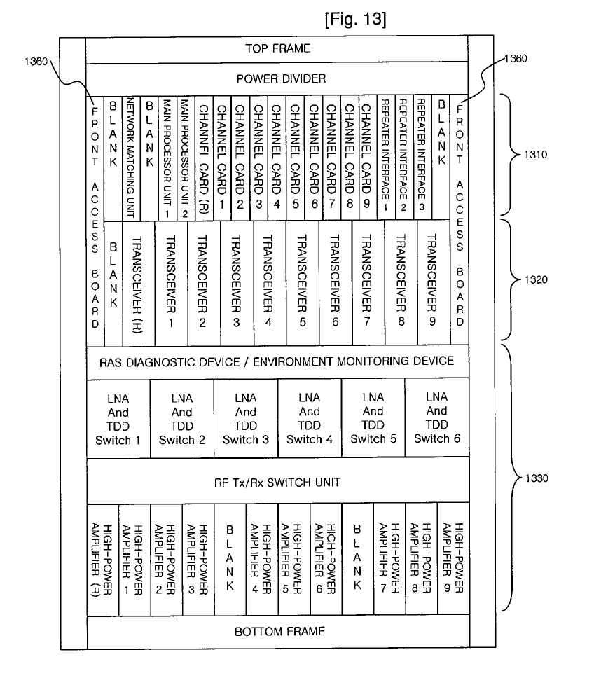

FIG. 13 is a view illustrating an example where units of the RAS system shown in FIG. 2 are partitioned into several shelves and insert to a frame. As illustrated in HG. 13, units of the RAS system 200 illustrated in FIG. 2 can be inserted to a single frame partitioned into the several shelves 1310, 1320, and 1330. Besides, the frame can further include other shelves, a power source distributor shelf, etc.

Particularly, when a single frame includes the channel card unit 230, the transceiver unit 240, the high-power amplifier unit 260, the RF switch unit, and the TDD switch unit 280 in the present invention, so as to get easy access to cards in a first shelf 1310 including at least ten cards of the channel card unit 230 and to cards in a second shelf 1320 including at least ten cards of the transceiver unit 240, the frame embeds a front access board 1360 that can be separated or inserted in the front side of the frame. The front access board 1360 has, in the front side thereof, a predetermined port connected to signal lines for connecting between any card(s) in the first shelf 1310 and any card(s) in the second shelf 1320, or to input/output signal lines in predetermined nodes for tests in any card(s). In this manner, it can be easy to maintain/repair the RAS system 200 by inputting a predetermined signal to a relevant card or outputting a signal from a predetermined node of the relevant card, through the front side port installed at the front access board 1360. Of course, a back board can be installed in the back (not illustrated) of the frame, and the above front access board 1360 can be connected even to the back board.

On this account, the RAS system 200 according to the present invention can simplify signal lines, etc. for interfacing interface between the shelves by using the front access board 1360, and has the structure causing the maintenance/repair to be easy in the front side. Namely, in a case where it causes complex cable connections to connect the signals necessary for an interface between the shelves with prescribed cables in the front side, the complex cable connections can be simplified by accomplishing a connection for a relevant interface between the shelves by using the front access board 1360 causes. Also, even in a case where it is hard to perform a connection task for substitution in the front side due to a confined space with too many connected cables, and also difficult to get access to a certain card, even though it is necessary to substitute a normal card for the certain card among the cards in the shelves for the maintenance/repair, since the certain card can be separated or inserted without affecting other operating cards by using the front access board 1360, advantages are offered in that it is easy to maintain/repair the RAS system in the front side.

As described in the above, in the RAS system 200 of the TDD scheme according to an embodiment of the present invention, if the main processor unit 210 generates switching control signals in response to the sensed failures on sensing a failure in any of the channel cards and the transceivers or a failure in any of the high-power amplifiers, all supporting M (i.e., the number of FAs equal to or more than three) and K (i.e., the number of sectors equal to or more than three), between the transceivers and the predetermined TDD switches connected to the antennas, the RF Rx switch unit 270 switches a path according to the generated switching control signals so as to substitute the failed module either by one additional redundancy transceiver per M and K or by one additional redundancy high-power amplifier per M and K. As a result, an efficient N+1 redundancy structure is embodied. Also, since the repeater interface 290 communicates with the repeater by using the IF between the baseband and the carrier frequency between the channel card unit 230 and the repeater for covering all directions of the predetermined sector, the service coverage can be expanded with economic efficiency. Furthermore, as the interface between the shelves is implemented by the front access board 1360 that can be separated or inserted in the front side, it is easy to simplify the signal cables and to maintain/repair the RAS system.

While this invention has been described in connection with what is presently considered to be the most practical and preferred embodiment, it is to be understood that the invention is not limited to the disclosed embodiment and the drawings, but, on the contrary, it is intended to cover various modifications and variations within the spirit and scope of the appended claims.

1. A Radio Access Station (RAS) system of a Time Division Duplex (TDD) scheme supporting a predetermined number (M) of Frequency Assignments (FAs) and a predetermined number (K) of sectors, the RAS system comprising:
a transceiver unit including an (M×K) number of transceivers and a redundancy transceiver;
a high-power amplifying unit including an (M×K) number of high-power amplifiers and a redundancy high-power amplifier;
a processor for generating a first switching control signal on sensing a failure of the transceivers and generating a second switching control signal on sensing a failure of the high-power amplifiers; and
a Radio Frequency (RF) switch unit for switching a transmission path to the redundancy transceiver and the redundancy high-power amplifier in response to the first switching control signal, and switching a transmission path to the redundancy high-power amplifier in response to the second switching control signal.

2. The RAS system as claimed in claim 1, wherein the RF switch unit comprises:
a first RF Transmission (Tx) switch unit including switches for disconnecting the transceiver whose failure is sensed in response to the first switching control signal, and connecting the transmission path to the redundancy transceiver, and including switches for disconnecting a high-power amplifier corresponding with the transceiver whose failure is sensed, and connecting the transmission path to the redundancy high-power amplifier; and
a second RF Tx switch unit for connecting the transmission path by switching a TDD switch corresponding with the transceiver whose failure is sensed to the redundancy high-power amplifier in response to the first switching control signal, and connecting the transmission path by switching a TDD switch corresponding with the high-power amplifier whose failure is sensed to the redundancy high-power amplifier in response to the second switching control signal.

3. The RAS system as claimed in claim 1, wherein the RF switch unit further comprises an RF Receive (Rx) switch unit for switching a receive path to the redundancy transceiver in response to a third switching control signal generating from the processor in a case where failures of the transceivers are sensed.

4. The RAS system as claimed in claim 1, wherein the RAS system further comprises a TDD switch unit including TDD switches corresponding with antennas on a four-by-four basis for each of the sectors, wherein each of the TDD switches transmits four receive signals copied for 4Rx diversity to the transceiver unit.

5. The RAS system as claimed in claim 4, wherein each of the TDD switches comprises:
a circulator for selectively transmitting a transmission signal from the high-power amplifier unit or receiving a signal from the antenna;
a Band-Pass Filter (BPF) connected between the circulator and any one relevant antenna among the antennas; and
an amplifier for amplifying a signal received from the circulator.

6. The RAS system as claimed in claim 1, wherein the RAS system further comprises a repeater for covering omni-directions of the sector and a repeater interface for supporting an FA interface with the repeater, wherein the repeater interface communicates with the repeater by using the Intermediate Frequency (IF) between a baseband and the carrier frequency.

7. The RAS system as claimed in claim 6, wherein the repeater interface comprises:
a transmission logic for synthesizing signals received from channel cards into one signal, and transmitting the synthesized signals the repeater; and
a receiving logic for separating signals respectively corresponding with the channel cards from a received signal, and respectively transmitting the separated signals to the channel cards.

8. The RAS system as claimed in claim 7, wherein the transmission logic comprises:
frequency down-converters for respectively down-converting signals having the first center frequency respectively received from the channel cards into baseband signals;
Low-Pass Filters (LPFs) for respectively filtering the baseband signals;
frequency up-converters for respectively up-converting filtered signals into signals respectively having the center frequencies different from one another; and
a frequency synthesizer for synthesizing the signals respectively having the center frequencies different from one another into one signal.

9. The RAS system as claimed in claim 7, wherein the receiving logic comprises:
frequency down-converters for separately receiving signals respectively having the center frequencies different from one another, and respectively down-converting the received signals respectively having the center frequencies different from one another into baseband signals;
LPFs for respectively filtering the baseband signals; and
frequency up-converters for respectively up-converting filtered signals into signals having the first center frequency.

10. The RAS system as claimed in claim 6, wherein the repeater interface transmits/receives signals to/from a channel card unit by using the first center frequency, transmits signals to the repeater by using the second center frequency, and receives signals from the repeater by using the third center frequency.

11. The RAS system as claimed in claim 10, wherein the repeater interface controls timing of a predetermined synchronizing signal corresponding to the reference of an Up Link (UL) and a Down Link (DL) received from the channel card unit, and transmits the synchronizing signal whose timing is controlled to the repeater.

12. The RAS system as claimed in claim 1, wherein the transceiver unit, the high-power amplifier unit, and the RF switch unit are embedded in a frame partitioned into a first shelf and a second shelf, and at least one signal line for a connection of the first shelf and the second shelf is interfaced via a front access board that can be separated and inserted in the front side.

13. A Radio Access Station (RAS) system of a Time Division Duplex (TDD) scheme supporting a predetermined number (M) of Frequency Assignments (FAs) and a predetermined number (K) of sectors, the RAS system comprising:
a channel card unit connected to a router via ethernet-based Layer 2 (L2) switching;
a transceiver unit for modulating digital data stream provided from the channel card unit into a transmission Radio Frequency (RF) signal, and for demodulating a received RF signal into digital data stream;
a high-power amplifier unit for amplifying a signal modulated by the transceiver unit; and
a repeater interface for respectively down-converting signals having the first center frequency received from the channel card unit into baseband signals, respectively up-converting the down-converted signals into signals respectively having the center frequencies different from one another, synthesizing the upconverted signals into one signal, and transmitting the synthesized signal to a repeater.

14. The RAS system as claimed in claim 13, wherein the repeater interface comprises:
frequency down-converters for respectively down-converting signals having the first center frequency respectively received from the channel cards into baseband signals;
Low-Pass Filters (LPFs) for respectively filtering the baseband signals;
frequency up-converters for respectively up-converting filtered signals into signals respectively having the center frequencies different from one another; and
a frequency synthesizer for synthesizing the signals respectively having the center frequencies different from one another into one signal.

15. The RAS system as claimed in claim 13, wherein the repeater interface separating signals respectively having the center frequencies different from one another transmitted from the repeater, respectively down-converts separated signals into baseband signals, respectively up-converts down-converted signals into signals having the first center frequency, and transmits up-converted signals to the channel card unit.

16. The RAS system as claimed in claim 15, wherein the repeater interface comprises:
frequency down-converters for separately receiving signals respectively having the center frequencies different from one another from the repeater, and respectively down-converting the received signals respectively having the center frequencies different from one another into baseband signals;
LPFs for respectively filtering the baseband signals; and
frequency up-converters for respectively up-converting filtered signals into signals, having the first center frequency.

17. The RAS system as claimed in claim 13, wherein the transceiver unit comprises an (M×K) number of transceivers and a redundancy transceiver, and the high-power amplifier unit comprises an (M×K) number of high-power amplifiers and a redundancy high-power amplifier.

18. The RAS system as claimed in claim 17, wherein the RAS system further comprises RF switch unit for switching a transmission path to the redundancy transceiver and the redundancy high-power amplifier in response to the first switching control signal generating on sensing failures of the transceivers, and switching a transmission path to the redundancy high-power amplifier in response to the second switching control signal generating on sensing failures of the high-power amplifiers.

19. The RAS system as claimed in claim 18, wherein the RF switch unit comprises:
a first RF Transmission (Tx) switch unit including switches for disconnecting the transceiver whose failure is sensed in response to the first switching control signal, and connecting the transmission path to the redundancy transceiver, and including switches for disconnecting a high-power amplifier corresponding with the transceiver whose failure is sensed, and connecting the transmission path to the redundancy high-power amplifier; and
a second RF Tx switch unit for connecting the transmission path by switching a TDD switch corresponding with the transceiver whose failure is sensed to the redundancy high-power amplifier in response to the first switching control signal, and connecting the transmission path by switching a TDD switch corresponding with the high-power amplifier whose failure is sensed to the redundancy high-power amplifier in response to the second switching control signal.

20. The RAS system as claimed in claim 18, which further comprises an RF Receive (Rx) switch unit for switching a receive path to the redundancy transceiver in response to a third switching control signal generating on sensing failures of the transceivers in a duration of receive.

21. The RAS system as claimed in claim 13, wherein the RAS system further comprises a TDD switch unit including TDD switches corresponding with antennas on a four-by-four basis for each of the sectors, wherein each of the TDD switches transmits four receive signals copied for 4 Rx diversity to the transceiver unit.

22. The RAS system as claimed in claim 21, wherein each of the TDD switches comprises:
a circulator for selectively transmitting a signal from the high-power amplifier unit or receiving a signal from the antenna;
a Band-Pass Filter (BPF) connected between the circulator and any one relevant antenna among the antennas; and
an amplifier for amplifying a signal received from the circulator.

23. A method of communications in a Radio Access Station (RAS) system based on a Time Division Duplex (TDD) scheme supporting a predetermined number (M) of Frequency Assignments (FAs) and a predetermined number (K) of sectors, the method comprising the steps of:
(A-1) sensing a failure of any one among transceivers and high-power amplifiers;
(A-2) connecting a receive path to a redundancy transceiver in a case of sensing a failure of any one among the transceivers; and
(A-3) switching a transmission path to the redundancy transceiver and a redundancy high-power amplifier in a case of sensing a failure of any one among the transceivers, and switching a transmission path to the redundancy high-power amplifier in a case of sensing a failure of any one among the high-power amplifiers,
wherein the RAS system comprises a transceiver unit including an (M×K) number of the transceivers and the redundancy transceiver; and a high-power amplifying unit including an (M×K) number of the high-power amplifiers and the redundancy high-power amplifier.

24. The method as claimed in claim 23, wherein in step (A-3), a TDD switch corresponding with the transceiver whose failure is sensed or the high-power amplifier whose failure is sensed is switched to the redundancy high-power amplifier, and a transmission path is connected.

25. A method of communications in a Radio Access Station (RAS) system based on a Time Division Duplex (TDD) scheme supporting a predetermined number (M) of Frequency Assignments (FAs) and a predetermined number (K) of sectors, the method comprising the steps of:
(B-1) down-converting signals having the first center frequency respectively received from a channel card unit into baseband signals, respectively;
(B-2) up-converting the baseband signals into signals respectively having the center frequencies different from one another, respectively; and
(B-3) synthesizing the up-converted signals into one signal, and transmitting the synthesized signal to a repeater,
wherein the RAS system comprises the channel card unit, a transceiver unit, a high-power amplifier unit, and a repeater interface.

26. The method as claimed in claim 25, which further comprises a step of low-pass filtering the baseband signals, wherein the step of low-pass filtering follows step (B-1).

27. The method as claimed in claim 25, further comprising the steps of:
(B-4) receiving signals respectively having the center frequencies different from one another from the repeater, separately, and down-converting the received signals respectively having the center frequencies different from one another into baseband signals, respectively; and
(B-5) up-converting the down-converted signals into signals having the first center frequency, respectively, wherein step (B-4) follows step (B-3).

28. The method as claimed in claim 27, which further comprises a step of low-pass filtering the baseband signals, wherein the step of low-pass filtering follows step (B-4).
